(19) United States
(12) Patent Application Publication
(10) Pub. No.: US 2021/0180526 A1
(43) Pub. Date: Jun. 17, 2021

(54) VALVE HOUSING, EXHAUST-GAS VALVE, EXHAUST SYSTEM, VEHICLE, AND METHOD OF MANUFACTURING AN EXHAUST-GAS VALVE

(71) Applicant: Faurecia Emissions Control Technologies, Germany GmbH, Augsburg (DE)

(72) Inventors: Bastien Perichon, Augsburg (DE); Francois Fernand, Augsburg (DE); Otto Steinhauser, Augsburg (DE)

(21) Appl. No.: 17/120,367

(22) Filed: Dec. 14, 2020

(30) Foreign Application Priority Data
Dec. 17, 2019 (DE) 10 2019 134 663.0

(51) Int. Cl. F02D 9/10; F02M 26/21; F02M 26/70; F02M 26/64

(52) U.S. Cl. CPC F02D 9/1035; F02M 26/64; F02M 26/70; F02M 26/21

(57) ABSTRACT

A valve housing for an exhaust-gas valve includes a first housing half-shell and a second housing half-shell, wherein the first housing half-shell and the second housing half-shell complement each other to form the valve housing. A first valve seat for a valve flap assembly and a swivel bearing mount to swivel mount the valve flap assembly are formed exclusively on the first housing half-shell. Furthermore, an exhaust-gas valve having such a valve housing and an exhaust system having such an exhaust-gas valve are presented. A vehicle having such an exhaust system is also presented. In addition, a method of manufacturing an exhaust-gas valve is explained.

### CROSS-REFERENCE TO RELATED APPLICATIONS

This application is a U.S. non-provisional application claiming the benefit of German Application No. 10 2019 134 663.0, filed on Dec. 17, 2019, which is incorporated herein by reference in its entirety.

### TECHNICAL FIELD

The disclosure relates to a valve housing for an exhaust-gas valve, comprising a first housing half-shell and a second housing half-shell, wherein the first housing half-shell and the second housing half-shell complement each other to form the valve housing.

The disclosure also relates to an exhaust-gas valve having such a valve housing.

Furthermore, the disclosure is directed to an exhaust system having such an exhaust-gas valve, and to a vehicle having such an exhaust system.

In addition, the disclosure relates to a method of manufacturing an exhaust-gas valve having a valve housing comprising a first housing half-shell and a second housing half-shell, and having a valve flap assembly.

### BACKGROUND

Valve housings, exhaust-gas valves, exhaust gas systems, vehicles and methods of manufacturing exhaust-gas valves are known from the prior art.

The general aim is to design the aforementioned objects such that they can be manufactured in a cost-effective manner Accordingly, associated manufacturing methods should also be adapted to be realized in a cost-effective manner

At the same time, exhaust-gas valves, exhaust systems and vehicles must function reliably during operation. Valve housings, exhaust-gas valves and exhaust systems in particular can be exposed to high temperatures resulting from hot exhaust-gas flows. As exhaust systems often also include components which are only temperature-resistant up to a certain limit, exhaust-gas valves are also used to separate such components from hot exhaust-gas flows when necessary. It is of particular importance that the exhaust-gas valve closes tightly, i.e. that it allows no or only slight leakage in the closed state. Otherwise, there is a risk that the components with limited temperature resistance will be damaged.

It is clear that a small leakage, which requires a precise matching of the components of an exhaust-gas valve to each other, conflicts at least partially with a low-cost manufacturability. Therefore, when designing exhaust-gas valves, a compromise must always be found between a reliable function, in particular with regard to undesirable leakages, and low-cost manufacturability. The same applies to exhaust systems and vehicles equipped therewith.

### SUMMARY

The subject disclosure provides an improved exhaust-gas valve that addresses the conflict of objectives between a low-cost manufacturability and a reliable function. The disclosed exhaust-gas valve can be manufactured in a cost-effective manner and at the same time works reliably, i.e. in particular avoids or at least reduces undesirable leakages.

For this purpose a valve housing is provided that includes a first housing half-shell and a second housing half-shell, wherein the first housing half-shell and the second housing half-shell complement each other to form the valve housing. A first valve seat for a valve flap of a valve flap assembly is formed exclusively on the first housing half-shell, and a swivel bearing mount to swivel mount the valve flap within the valve housing is formed on the first housing half-shell.

Such a configuration of the valve housing facilitates the manufacture thereof and the fitting of the valve flap assembly in the valve housing. In this context, the valve flap assembly is fitted only on the first housing half-shell. This is comparatively simple, as only two assemblies need to be fitted together. In addition, a good accessibility of the valve flap assembly is ensured during fitting. This allows the valve flap assembly to be fitted quickly and precisely on the first housing half-shell. This results in a reliable function of an exhaust-gas valve equipped with the valve housing. In particular, it has only little or no undesirable leakage. The second housing half-shell is therefore not required at all for fitting the valve flap assembly. It is placed onto the first housing half-shell in a subsequent fitting step. The fitting of an exhaust-gas valve having such a valve housing can thus generally be carried out quickly and with little effort.

In particular, the valve flap and/or swivel bearing mount is formed exclusively on the first housing half-shell.

The term “exclusively” means that the first valve seat or the swivel bearing mount is completely formed on the first housing half-shell, i.e. no part of the first valve seat or of the swivel bearing mount is formed on the second housing half-shell, and/or that no first valve seat or swivel bearing mount at all is formed on the second housing half-shell.

Preferably, the first housing half-shell and/or the second housing half-shell are formed sheet metal parts or is a formed sheet metal part. In particular, the first housing half-shell and/or the second housing half-shell are stamped-bent parts or is a stamped-bent part or deep-drawn parts or a deep-drawn part. Such housing half-shells can be produced at comparatively low cost. Formed sheet metal parts are in particular excellently suited for manufacture within the context of a mass production. Formed sheet metal parts can still be produced easily and cost-effectively even if they have a comparatively complex shape as functionally integrated components. The valve housing may thus be produced easily and cost-effectively in large quantities.

The valve housing may be a 3-way valve housing. The valve housing can therefore have three fluid connections, in particular exhaust-gas connections. The valve housing can thus be used in numerous cases of application in the field of exhaust-gas valves.

In one embodiment, a second valve seat for the valve flap is formed on the first housing half-shell, in particular it is formed exclusively on the first housing half-shell. Here, the term “exclusively” is to be understood again as already explained with regard to the first valve seat. The second valve seat is thus completely formed on the first housing half-shell, i.e. no part of the second valve seat is formed on the second housing half-shell and/or no second valve seat is formed at all on the second housing half-shell. The second valve seat is separate from the first valve seat. Preferably, the first valve seat is assigned to a first position of the valve flap, and the second valve seat is assigned to a second position of the valve flap which is separate therefrom. This means that the valve flap can only cooperate with valve seats that are provided on the same component, namely on the first housing half-shell. Therefore, the valve flap can be easily and reliably aligned with respect to the first valve seat and the second valve seat so that a high degree of tightness is ensured in the corresponding positions of the valve flap. In other words, unwanted leakage is avoided or at least significantly reduced.

According to a variant, the swivel bearing mount comprises two bearing openings for receiving a valve flap shaft of the valve flap assembly, the bearing openings being arranged opposite each other in the first housing half-shell. The valve flap shaft can be inserted into the two bearing openings. In particular, additional bearing elements and/or sealing elements are provided within the bearing openings for this purpose. This results in a simple and reliable mounting of the valve flap shaft. In addition, it can be fitted comparatively quickly on the first housing half-shell.

The first housing half-shell and the second housing half-shell can be connected to each other by a weld seam or a soldered seam. The first housing half-shell and the second housing half-shell are thus reliably connected to each other. At the same time, such a connection can be created using standard manufacturing methods and production equipment. In particular, a laser welding method, a metal active gas welding method or a soldering method may be used for this purpose. In addition, the two housing half-shells can be connected to each other in a gas-tight manner by the weld seam or the soldered seam. Alternatively, a seal may be provided between the first housing half-shell and the second housing half-shell so that only a mechanical connection between the housing half-shells has to be made by the weld seam or the soldered seam.

Furthermore, the first housing half-shell and the second housing half-shell may each have a connecting edge which is angled outwards, the housing half-shells being fastened to each other via the connecting edges. Preferably, the housing half-shells lie flat against each other via the connecting edges. The housing half-shells can thus be fastened to each other and sealed against each other relatively easily.

Alternatively, the first housing half-shell or the second housing half-shell may have a connecting edge. Here, the connecting edge extends from a housing wall of the first housing half-shell or a housing wall of the second housing half-shell and is offset outwards parallel to the housing wall. In addition, the housing half-shells are fastened to each other via the connecting edge. In this alternative, only one of the housing half-shells has a connecting edge. The housing half-shell having no connecting edge is inserted into a space within the connecting edge provided on the other housing half-shell. Such a connecting edge is colloquially referred to as a shoe box edge and such a connection as a shoebox connection. This is because the two housing half-shells are put together in the same way as a shoe box and the lid thereof.

For above purpose an exhaust-gas valve is provided, which has a valve housing according to the disclosure and is equipped with a valve flap assembly. The valve flap assembly comprises a valve flap and a valve flap shaft. The valve flap shaft is received in the swivel bearing mount such that the valve flap can be swiveled within the valve housing. Thus, the valve flap assembly is mounted exclusively on the first housing half-shell. The associated valve flap is therefore located within the valve housing. Due to the features and effects already mentioned for the valve housing, such an exhaust-gas valve can be installed comparatively quickly and easily. In addition, such an exhaust-gas valve has only a low level of undesirable leakage, as the valve flap assembly is precisely aligned with respect to the valve housing. This makes such an exhaust-gas valve particularly suitable for reliably protecting temperature-sensitive components against undesired heat and/or temperature effects. Furthermore, the features and advantages mentioned with regard to the valve housing apply equally to the exhaust-gas valve and vice versa.

In addition, for above purpose an exhaust system is provided having an exhaust-gas valve according to the disclosure. The features and advantages mentioned for the valve housing and the exhaust-gas valve apply equally to such an exhaust system.

The exhaust system may have a heat recovery system for recovering heat from exhaust gas and/or an exhaust gas recirculation system for introducing exhaust gas into an intake tract. The exhaust-gas valve may be a component of the heat recovery system and/or the exhaust gas recirculation system, in particular wherein an exhaust-gas supply to the heat recovery system and/or the exhaust gas recirculation system is adapted to be shut off by the exhaust-gas valve. Thus, the heat recovery system and/or the exhaust gas recirculation system can be reliably protected against the influence of high temperatures. These result in particular from hot exhaust-gas flows.

For above purpose, a vehicle having an exhaust system according to the disclosure is provided. The features and advantages mentioned for the valve housing, the exhaust-gas valve and the exhaust system apply equally to such a vehicle.

In addition, for above purpose a method of the type initially mentioned of manufacturing an exhaust-gas valve is provided, comprising the following steps:

a) mounting the valve flap assembly in the first housing half-shell so that a valve flap of the valve flap assembly is adapted for swiveling movement within the first housing half-shell, and

b) subsequently fastening the second housing half-shell to the first housing half-shell, the first housing half-shell and the second housing half-shell complementing each other to form the valve housing.

Thus, the valve flap assembly is initially fitted only on the first housing half-shell. The second housing half-shell thus only needs to be fastened to the first housing half-shell. The second housing half-shell is therefore only indirectly connected to the valve flap assembly. This generally results in a fast and cost-effective manufacture of the exhaust-gas valve. As the valve flap only has to be fitted directly in the first housing half-shell, the corresponding areas are easily accessible. This enables a precise fitting. Incidentally, the features and advantages mentioned for the valve housing, the exhaust-gas valve, the exhaust system and the vehicle apply equally to the method and vice versa.

The valve flap assembly can be aligned with at least one valve seat provided for cooperation with the valve flap. The alignment is carried out in particular during the fitting of the valve flap assembly and further in particular before the second housing half-shell is fastened to the first housing half-shell. The valve flap assembly is therefore easily accessible for alignment. Preferably, the at least one valve seat is provided on the first housing half-shell. The alignment of the valve flap assembly is thus no longer affected by the fitting of the second housing half-shell. Thus, an exhaust-gas valve may be manufactured which has no or only a small amount of unwanted leakage.

### BRIEF DESCRIPTION OF THE DRAWINGS

The disclosure will be explained below using various example embodiments shown in the attached drawings in which:

FIG. 1 shows a motor vehicle according to the disclosure having an exhaust system according to the disclosure, which comprises an exhaust-gas valve according to the disclosure which has a valve housing according to the disclosure, the exhaust-gas valve being manufactured by a method according to the disclosure,

FIG. 2 shows a detail of the exhaust system according to the disclosure from FIG. 1,

FIG. 3 shows the valve housing according to the disclosure from FIGS. 1 and 2 in a perspective detail view,

FIG. 4 shows a first housing half-shell of the valve housing from FIG. 3,

FIG. 5 shows a second housing half-shell of the valve housing from FIG. 3,

FIG. 6 shows a valve housing according to the disclosure in an alternative embodiment,

FIG. 7 shows a first housing half-shell of the valve housing from FIG. 6, and

FIG. 8 shows a second housing half-shell of the valve housing from FIG. 6.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C”. The same holds true for listings with more than two items.

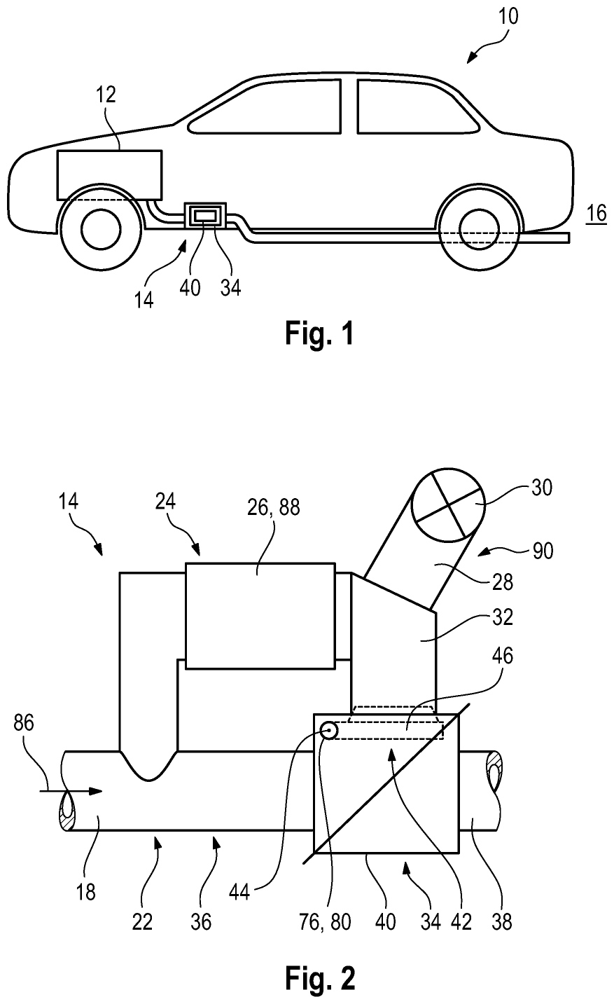

FIG. 1 shows a vehicle 10 having an internal combustion engine 12 coupled to an exhaust system 14. The purpose of the exhaust system 14 is to direct exhaust gas generated by the internal combustion engine 12 to an environment 16.

As shown in FIG. 2, the exhaust system 14 comprises an engine-side exhaust-gas line 18 in the form of an engine-side exhaust-gas pipe.

The latter is adjoined by a branching point 22, from which a first branch 24 of the exhaust system 14 and a second branch 36 originate.

The first branch 24 is fluidically coupled with an exhaust gas recirculation line 28 and an exhaust gas recirculation valve 30.

The first branch 24 is also equipped with a heat exchanger 26.

In addition, the first branch 24 is connected to an exhaust-gas valve 34 via an outflow line 32.

The second branch 36 is configured without a heat exchanger and opens into the exhaust-gas valve 34.

On the ambient side, an outlet line 38 is provided on the exhaust-gas valve 34.

The exhaust-gas valve 34 comprises a valve housing 40 and a valve flap assembly 42, wherein the valve flap assembly 42 in turn includes a valve flap shaft 44 and a valve flap 46.

As in the representation of FIG. 2 the valve flap assembly 42 is located within the valve housing 40, the hidden components of the valve flap assembly 42 are shown as dashed lines.

The valve flap 46 is mounted for swiveling movement in the valve housing 40 via the valve flap shaft 44.

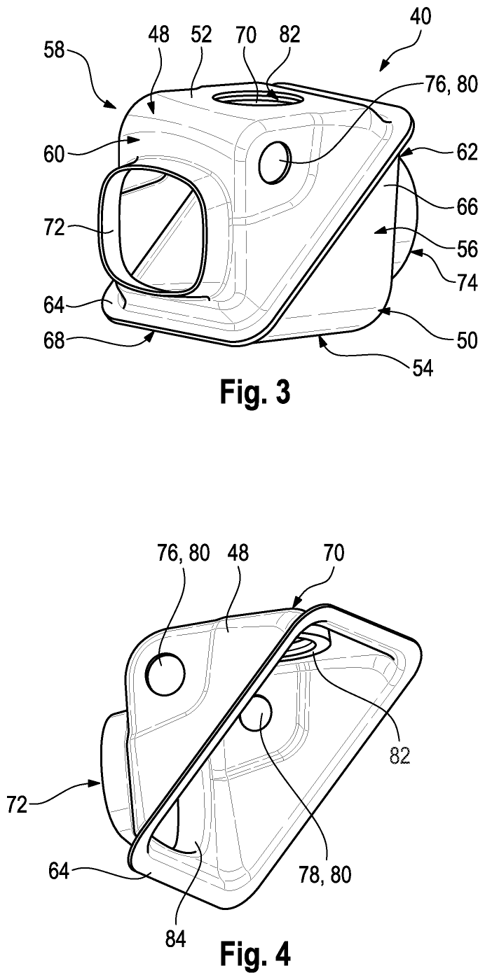

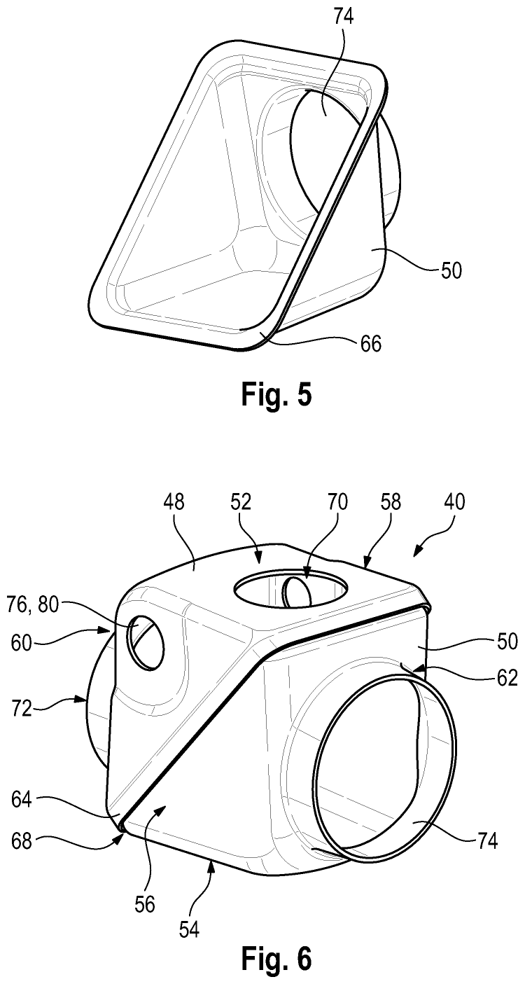

The valve housing 40 is shown in detail in FIGS. 3 to 5.

It comprises a first housing half-shell 48 and a second housing half-shell 50, which complement each other to form the valve housing 40.

The valve housing 40 has a substantially cuboid shape.

Both the first housing half-shell 48 and the second housing half-shell 50 are formed sheet metal parts which were produced by deep drawing in the example embodiment shown. In other words, the first housing half-shell 48 and the second housing half-shell 50 are both deep-drawn parts.

In the illustration according to FIG. 3, the valve housing 40 in this context has a top side 52 and a bottom side 54 opposite the top side 52.

The top side 52 and the bottom side 54 are connected by a front side 56 and a rear side 58, and by a left side 60 and a right side 62.

The front side 56 and the rear side 58 are located on opposite sides of the valve housing 40. The same applies to the left side 60 and the right side 62.

Respective adjoining sides are substantially at right angles to each other. Thus, the front side 56 is substantially perpendicular to the top side 52, the left side 60, the right side 62 and the bottom side 54. The same applies to the other sides.

In addition, the first housing half-shell 48 and the second housing half-shell 50 complement each other such that the top side 52 and the left side 60 are completely formed by the first housing half-shell 48.

The bottom side 54 and the right side 62 are completely formed by the second housing half-shell 50.

The front side 56 and the rear side 58 are each partly formed by the first housing half-shell 48 and the second housing half-shell 50.

More precisely, in the illustration according to FIG. 3, an upper left part of the front side 56 is formed by the first housing half-shell 48, and a lower right part of the front side 56 is formed by the second housing half-shell 50. The same applies to the rear side 58.

In other words, the front side 56 and the rear side 58 are divided diagonally, the individual parts being formed by different housing half-shells 48, 50.

In order to be able to connect the housing half-shells 48, 50 with each other, a first connecting edge 64 is provided on the first housing half-shell 48 and a second connecting edge 66 is provided on the second housing half-shell 50.

The first connecting edge 64 is angled outwards with respect to the first housing half-shell 48, i.e. it is angled outwards in sections with respect to the front side 56, the left side 60, the rear side 58 and the top side 52.

The first connecting edge 64 is completely circumferential.

The second connecting edge 66 is angled outwards with respect to the second housing half-shell 50. More precisely, it is angled outwards in sections with respect to the front side 56, the bottom side 54, the rear side 58 and the right side 62.

The connecting edges 64, 66 are contiguous to each other and are connected by a weld seam 68. Thus, the first housing half-shell 48 and the second housing half-shell 50 are also connected to each other the weld seam 68 or the soldered seam.

In addition, a first flow opening 70 is provided on the top side 52 which, when installed in the exhaust system 14, is fluidically connected to the outflow line 32 (see FIG. 2).

A second flow opening 72 which is fluidically connected to the second branch 36 when the exhaust-gas valve 34 is fitted in the exhaust system 14 is provided on the left side 60 (see FIG. 2).

Furthermore, a third flow opening 74 is provided on the right side 62. It is fluidically connected to the outlet line 38 inside the exhaust system 14 (see FIG. 2).

In addition, a first bearing opening 76 is formed on the first housing half-shell 48 on the front side 56.

A second bearing opening 78 is also formed on the first housing half-shell 48, but on the rear side 58 thereof.

Thus, the first bearing opening 76 and the second bearing opening 78 are opposite each other on the first housing half-shell 48.

The two bearing openings 76, 78 together form a swivel bearing mount 80, which is formed exclusively on the first housing half-shell 48.

In the fitted state of the exhaust-gas valve 34, the valve flap shaft 44 is received in the swivel bearing mount 80. More precisely, the valve flap shaft 44 is inserted at its opposite ends into the bearing openings 76, 78.

Thus, the valve flap assembly 42 is mounted on the valve housing 40 as a whole. The valve flap 46 is adapted for swiveling movement with respect to the valve housing 40.

Furthermore, a first valve seat 82 is formed in the area of the first flow opening 70 for cooperation with the valve flap 46.

A second valve seat 84 which is separate from the first valve seat 82 is formed in the area of the second flow opening 72.

Both the first valve seat 82 and the second valve seat 84 are formed exclusively on the first housing half-shell 48.

The valve seats 82, 84 are formed integrally on the first housing half-shell 48.

During operation of the exhaust system 14, exhaust gas can flow through the exhaust-gas line 18 in a flow direction symbolized by an arrow 86 (see FIG. 2).

The exhaust gas can get into the first branch 24 via the branching point 22.

It then also flows through the heat exchanger. It is thus possible to recover heat from the exhaust-gas flow, more precisely from the partial flow in the first branch 24. Thus, the heat exchanger 26 constitutes a part of a heat recovery system 88.

Starting from the first branch 24, the exhaust-gas flow can also selectively be fed back into an intake tract of the internal combustion engine 12 via the exhaust gas recirculation line 28 and the exhaust gas recirculation valve 30. In this respect, the exhaust gas recirculation line 28 and the exhaust gas recirculation valve 30 are components of an exhaust gas recirculation system 90.

Alternatively or additionally, the exhaust-gas flow from the first branch 24 can be directed via the first flow opening 70 into the outlet line 38. This is of course only the case if the first flow opening 70 is not closed by the valve flap 46. The valve flap 46 must therefore not rest against the first valve seat 82.

From there, the exhaust-gas flow can reach the environment 16.

That part of the exhaust gas which flows from the branching point 22 into the second branch 36 can, if the valve flap 46 is in the appropriate position, be directed via the second flow opening 72 into the exhaust-gas valve 34 and from there into the outlet line 38. The valve flap 46 must therefore not rest against the second valve seat 84.

The mentioned flow paths for the exhaust gas can be influenced by using the exhaust-gas valve 34. In particular, the exhaust-gas valve 34, more precisely the valve flap 46, can assume a first valve position in which the valve flap 46 rests against the first valve seat 82 and thus closes the first flow opening 70.

The valve flap 46 can also assume a second valve position, in which the valve flap 46 rests against the second valve seat 84 and closes the second flow opening 72.

The exhaust-gas valve 34 is therefore a 3-2-way valve.

To manufacture the exhaust-gas valve 34, the valve flap assembly 42 is first fitted in the first housing half-shell 48.

On the one hand, the valve flap shaft 44 is inserted into the bearing openings 76, 78.

On the other hand, the valve flap 46 is aligned with the first valve seat 82 and/or the second valve seat 84.

The second housing half-shell 50 is fastened to the first housing half-shell 48 only when the valve flap assembly 42 has been completely fitted on the first housing half-shell 48 and finally aligned with the associated valve seats 82, 84. The housing half-shells 48, 50 are then welded or soldered together.

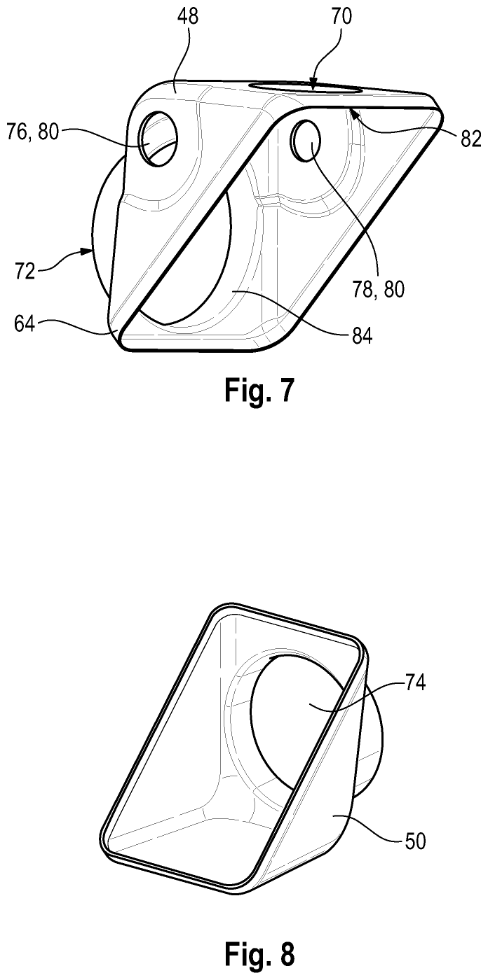

FIGS. 6 to 8 show a valve housing 40 according to a further embodiment. The latter substantially corresponds to the first embodiment which has already been explained with reference to FIGS. 3 to 5. Therefore, only the differences will be discussed below. Identical and functionally identical parts are provided with the same reference numerals.

In the valve housing 40 according to FIGS. 6 to 8, only the first housing half-shell 48 is equipped with a connecting edge 64.

The connecting edge 64 starts out from a housing wall section forming the front side 56, a housing wall section forming the left side 60, a housing wall section forming the rear side 58, and a housing wall section forming the top side 52, and is offset outwards parallel to these housing wall sections.

The connecting edge 64 is again designed to be completely circumferential.

The connecting edge 64 is further configured such that the second housing half-shell 50, which is designed without a connecting edge, can be inserted into a space provided by the connecting edge 64.

Then, the housing half-shells 48, 50 can again be fastened to each other via a weld seam 68 or a soldered seam.

Although various embodiments have been disclosed, a worker of ordinary skill in this art would recognize that certain modifications would come within the scope of this disclosure. For that reason, the following claims should be studied to determine the true scope and content of this disclosure.

1. A valve housing for an exhaust-gas valve, comprising:
a first housing half-shell and a second housing half-shell, wherein the first housing half-shell and the second housing half-shell complement each other to form the valve housing, and wherein a first valve seat for a valve flap of a valve flap assembly is formed on the first housing half-shell; and
a swivel bearing mount configured to swivel mount the valve flap within the valve housing is formed on the first housing half-shell.

2. The valve housing according to claim 1, wherein at least one of the first housing half-shell and the second housing half-shell are formed sheet metal parts or is a formed sheet metal part.

3. The valve housing according to claim 1, wherein the valve housing is a 3-way valve housing.

4. The valve housing according to claim 1, wherein a second valve seat for the valve flap is formed on the first housing half-shell.

5. The valve housing according to claim 4, wherein the second valve seat for the valve flap is formed exclusively on the first housing half-shell.

6. The valve housing according to claim 1, wherein the swivel bearing mount comprises two bearing openings to receive a valve flap shaft of the valve flap assembly, the two bearing openings being arranged opposite each other in the first housing half-shell.

7. The valve housing according to claim 1, wherein the first housing half-shell and the second housing half-shell are connected to each other by a weld seam or a soldered seam.

8. The valve housing according to claim 1, wherein the first housing half-shell and the second housing half-shell each have a connecting edge which is angled outwards, the first and the second housing half-shells being fastened to each other via the connecting edges.

9. The valve housing according to claim 1, wherein the first housing half-shell or the second housing half-shell has a connecting edge, wherein the connecting edge extends from a housing wall of the first housing half-shell or a housing wall of the second housing half-shell and is offset outwardly parallel to the housing wall, and wherein the first and the second housing half-shells are fastened to each other via the connecting edge.

10. An exhaust-gas valve comprising:
a valve housing comprising a first housing half-shell and a second housing half-shell, wherein the first housing half-shell and the second housing half-shell complement each other to form the valve housing;
a valve flap assembly comprising a valve flap and a valve flap shaft, wherein a first valve seat for the valve flap is formed on the first housing half-shell, and a swivel bearing mount to swivel mount the valve flap within the valve housing is formed on the first housing half-shell; and
wherein the valve flap shaft is received in the swivel bearing mount such that the valve flap is pivotable within the valve housing.

11. An exhaust system including the exhaust-gas valve according to claim 10.

12. A vehicle comprising:
an exhaust system;
an exhaust-gas valve comprising a valve housing and a valve flap assembly, wherein
the valve housing comprises a first housing half-shell and a second housing half-shell, wherein the first housing half-shell and the second housing half-shell complement each other to form the valve housing,
the valve flap assembly comprises a valve flap and a valve flap shaft, wherein a first valve seat for the valve flap is formed on the first housing half-shell, and a swivel bearing mount to swivel mount the valve flap within the valve housing is formed on the first housing half-shell; and
wherein the valve flap shaft is received in the swivel bearing mount such that the valve flap is pivotable within the valve housing.

13. The vehicle according to claim 12, wherein the exhaust system has at least one of a heat recovery system to recover heat from exhaust gas and an exhaust gas recirculation system to introduce exhaust gas into an intake tract, and wherein the exhaust-gas valve is a component of the at least one of the heat recovery system and of the exhaust gas recirculation system.

14. The vehicle according to claim 13, wherein an exhaust gas supply to the at least one of the heat recovery system and to the exhaust gas recirculation system is adapted to be shut off by the exhaust-gas valve.

15. A method of manufacturing an exhaust-gas valve comprising a valve housing having a first housing half-shell and a second housing half-shell, and a valve flap assembly, comprising the following steps:
a) mounting the valve flap assembly in the first housing half-shell so that a valve flap of the valve flap assembly is adapted for swiveling movement within the first housing half-shell, and
b) subsequently fastening the second housing half-shell to the first housing half-shell, the first housing half-shell and the second housing half-shell complementing each other to form the valve housing.

16. The method according to claim 15, wherein the valve flap assembly is aligned with at least one valve seat provided for cooperation with the valve flap.
